(19) United States
(12) Patent Application Publication
(10) Pub. No.: US 2007/0088816 A1
(43) Pub. Date: Apr. 19, 2007

(54) System and method for monitoring the status of a bus in a server environment

(75) Inventors: Nasiha Hrustemovic, Austin, TX (US); Philip D. Chidester, Austin, TX (US); Akkiah Maddukuri, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/250,813

(22) Filed: Oct. 14, 2005

(51) Int. Cl. G06F 15/173

(52) U.S. Cl. 709/224

(57) ABSTRACT

A system and method is disclosed in which the buses of a server computer are monitored through server management software. A data structure for a monitored bus or group of buses is created and stored in a repository of data structures for other monitored devices within the server computer. As events, such as failure events, occur on one or more of the monitored buses, the event is recorded in an event log. Using the server management software, monitoring commands can be issued by the baseboard management controller to each monitored bus to check the status of the bus.

### TECHNICAL FIELD

The present disclosure relates generally to computer systems and information handling systems, and, more particularly, to a system and method for monitoring the status of a bus in a server environment.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

A computer system, such as a server computer, may include a network interface controller that is communicatively coupled to microcontroller that resides on the motherboard of the server computer. The on-board microcontroller is sometimes referred to as a baseboard management controller. The baseboard management controller serves as a centralized processor for hardware-level management of the server computer. The baseboard management controller may be coupled to other physical elements of the server computer, including, for example, the remote access card, card temperature sensors, network interface card, and a power supply. The baseboard management controller may be coupled to these other devices by a bus between the two devices.

### SUMMARY

In accordance with the present disclosure, a system and method is disclosed in which the buses of a server computer are monitored through server management software. A data structure for a monitored bus or group of buses is created and stored in a repository of data structures for other monitored devices within the server computer. As events, such as failure events, occur on one or more of the monitored buses, the event is recorded in an event log. Using the server management software, monitoring commands can be issued by the baseboard management controller to each monitored bus to check the status of the bus.

The system and method disclosed herein is technically advantageous because it provides a technique for the remote monitoring of buses, including I²C buses, in the interior of a server computer. Through the use of the system and method disclosed herein, buses within the interior of a server computer can be monitored and the status of those buses can be reported, despite the loss of operating power to the server computer. Another technical advantage of the system and method disclosed herein is that the system and method disclosed herein employs the Intelligent Platform Management Interface (IPMI). A sensor is established in accordance with the IPMI specification for each of the I²C buses of the server computer. Once a data record for this sensor is established in the SDR repository, the status of each I²C bus in the server computer can be monitored using the established IPMI protocol. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of elements of a hardware architecture of an information handling system;

FIG. 2 is a flow diagram of a method for transmitting and executing IPMI commands concerning the status of buses within a server computer; and

FIG. 3 is a method for continuously monitoring an I²C bus of a server computer.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

The system and method disclosed herein concerns a technique for monitoring and reporting the status of buses, including I²C buses, within a server computer. In the hardware configuration of a server computer, a baseboard management controller may be coupled through I²C bus lines to other physical elements of the server computer. These other physical elements may include, for example, the network interface controller, the remote access card, temperature sensors, and a power supply. Using a management interface, such as the Intelligent Platform Management Interface (IPMI), a protocol and software tool is established to monitor the status of the I²C buses in the server computer, including the I²C buses coupled to the baseboard management controller.

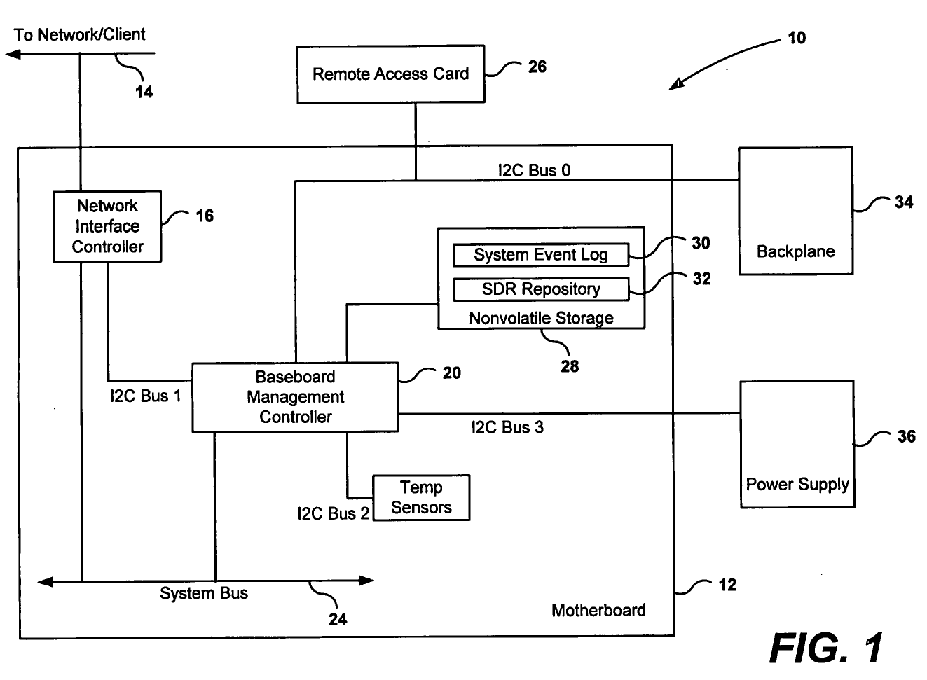

Shown in FIG. 1 are elements of a hardware architecture of an information handling system, such as a server computer, which is indicated generally at 10 A motherboard 12 includes a baseboard management controller 20 and a network interface controller 16. The network interface controller 16 and the baseboard management controller 20 are each coupled to a system bus 24. Network interface controller 16 serves as an interface between the server computer 10 and an external network or client 14. Baseboard management controller 20 is also coupled to a remote access card 26, which may not reside on motherboard 12. Nonvolatile storage 28 is also coupled to baseboard management controller 20 and reside on motherboard 12. Also coupled to baseboard management controller 20 is temperature sensor 21, which may reside on the motherboard or another board of the system, such as a control panel board. Temperature sensor 21 may comprise sensors for monitoring the temperature of the baseboard management controller or the interior of the server computer. Nonvolatile storage 28 includes a system event log 30 and a sensor data record (SDR) repository 32. Nonvolatile storage 28 is coupled to baseboard management controller 20.

In server computer 10, buses, such as I²C buses, are coupled between the baseboard management controller and some of the hardware elements of the server system. An I²C bus, labeled as I²C Bus 0, is coupled between the backplane 34, remote access card 26, and baseboard management controller 20. A second I²C bus, labeled I²C bus 1, is coupled between the baseboard management controller 20 and network interface controller 16. Another I²C bus, labeled in FIG. 1 as I²C bus 2 is coupled between baseboard management controller 20 and temperature sensors 21. An I²C bus, labeled as I²C bus 3, is coupled between the power supply 36 and the baseboard management controller 20.

Nonvolatile storage 28 includes a SDR repository 28 and a system event log 30. Sensor data records (SDR) repository 32 is a centralized, non-volatile storage location within the server computer. The SDR repository is managed by and can be accessed by the baseboard management controller. Stored in SDR repository are sensor data records, which comprise information and specifications for each sensor in the server computer. The SDR repository provides the server management software of the computer system with a data entry that describes the number, type, and configuration of each sensor of the server system. As an example, in the case of a temperature sensor, the SDR entry for the temperature sensor may include the parameters of the temperature sensor and any threshold operating values for the temperature sensor. Similarly, in the case of a bus sensor, the SDR entry would specify the error conditions of the bus that are monitored by the baseboard management controller. These error conditions could include arbitration errors, no stop conditions, lines stuck low, and the recovery policy of the bus. System event log 30 is a nonvolatile storage area that is a log of events that have been recognized by the server management software of the server system. As events occur, the server management software records those events in the system event log 30. An entry in the system event log will include, at a minimum, an identification of the sensor and the event experienced by the sensor.

One example of server management software is IPMI software. The IPMI protocol defines a set of established interfaces for the monitoring and reporting the status of components of a server computer. IPMI software is server management software that executes on the baseboard management controller. IPMI software employs the intelligence of the various hardware devices to present a common, standardized interface for monitoring and reporting on the status of the hardware devices within the server system. The IPMI protocol was established, in part, by Dell Inc. of Round Rock, Tex.; Hewlett-Packard Company of Palo Alto, Calif.; Intel Corporation of Santa Clara, Calif.; and NEC Corporation of Tokyo, Japan. The specification for the IPMI protocol can be found on the Intel web site at http://www.intel .com/design/servers/ipmi.

The system and method disclosed herein involves defining an IPMI bus sensor for each of the buses of the server system. The data record for each I²C bus sensor is saved to the SDR repository 32, and each bus is defined to the server management software as having the characteristics of a sensor. Once each I²C bus sensor is entered in the SDR repository, the IPMI software executing on the baseboard management controller causes the controller to monitor and identify various bus errors or conditions present in the I²C buses, including arbitration errors, traffic errors, and the existence of data or clock lines that are stuck at a logical low. As defined events occur on one or more of the I2C buses, the baseboard management controller records these events in the system event log.

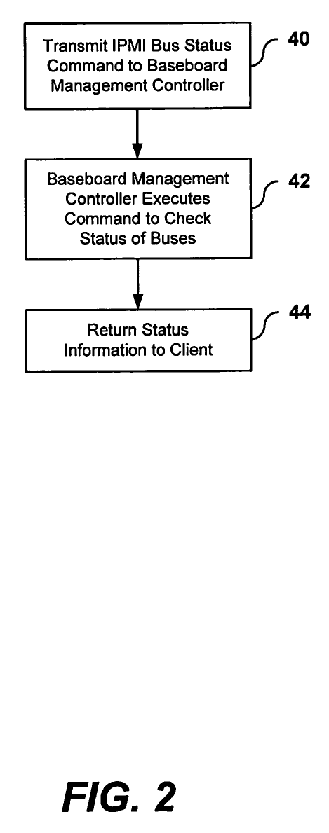

In operation, a client on the network 14 can issue an IPMI “get” command to evaluate the status of one or more of the I2C buses of the server computer. As an example an IPMI get command for I²C Bus 0 maybe the command:
Get Sensor Reading (I²C Bus 0)
The result of this command is a list of status values for the I²C Bus. This result is returned to the client that issued the get command or displayed in a monitor associated with the server computer. Shown in FIG. 2 is a flow diagram of a series of method steps for transmitting and executing IPMI commands concerning the status of buses within a server computer. At step 40, an IPMI bus status command is transmitted to the baseboard management controller. At step 42, the baseboard management controller executes a command to check the status of the bus or buses identified in the IPMI bus status command. At step 44, following the execution of the IPMI bus status command, the bus status information is returned to the client issuing the command. Step 42 is performed by the baseboard management controller continuously at a regular polling interval. When a client requests the status of a sensor, the baseboard management controller returns the information collected as part of the most recent polling operation on the sensor. For an I²C bus, the information that is recoded to the system event log could include the slave address of the J²C bus, multiplexer information (if applicable), and the number of times that a recover has occurred, if a recovery policy is in place for the bus.

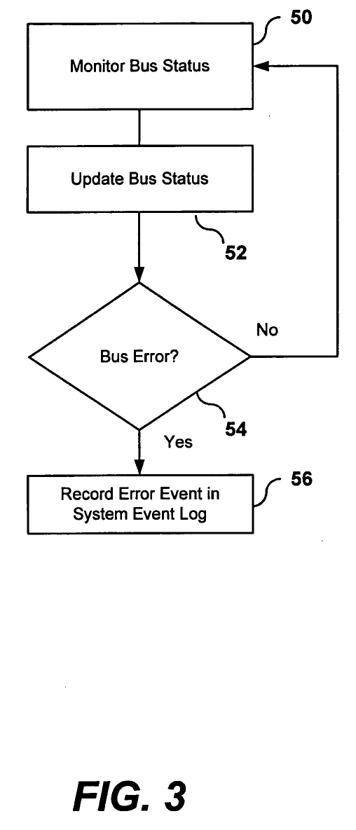

As an alternative to reporting the status of an I²C bus in the server computer in response to an IPMI command issued by a client computer, the status of the I²C bus could be monitored continuously for bus errors. Shown in FIG. 3 is a flow diagram of a series of method steps for continuously monitoring the status of one or more I²C buses coupled to the baseboard management controller of a server computer. At step 50, the status of the buses of the I²C buses is monitored. At step 52, the status of each monitored bus is updated at the baseboard management controller. Steps 50 and 52 are performed continuously at regular polling intervals to monitor and record the status of each monitored bus. At step 54, the current status of each bus is compared with the previous status of each bus. If it is determined at step 54 that one of the buses has reported an error, the bus status is updated (step 54) by recording the error event in the system event long. If there is no bus error, steps 50 and 52 are repeated until an error is recognized.

Because the baseboard management controller and the nonvolatile memory storage area of the SDR repository and system event log are separately powered, the system and method described herein can operate despite the loss of power to the remainder of the server computer. As a result, the status of the I²C buses of the server computer can be monitored despite the loss of operational power to the server computer.

The bus monitoring system of this disclosure has been described with reference to an implementation in which a data structure is established for each bus. Instead of establish a data structure for each bus, a single data structure could be established that represents the status of a group of buses. It should also be recognized that the system and method disclosed herein is not limited in its application to the IPMI specification or I²C buses. Rather, the system and method disclosed herein may be employed with any system management software to monitor any buses within a server computer. Although the present disclosure has been described in detail, it should be understood that various changes, substitutions, and alterations can be made hereto without departing from the spirit and the scope of the invention as defined by the appended claims.

What is claimed is:

1. A method for monitoring the status of a bus of a server computer from a client computer, wherein the server computer includes sensors that may be monitored through server management software, comprising:
establishing a data structure for the bus in a nonvolatile data repository in the server computer, wherein the data entry defines certain status parameters for the bus and wherein the status parameters comprise the sensor readings for the bus;
transmitting from the client computer to the server computer a command to cause the controller of the server computer to execute a command to retrieve the status of the bus of the server computer;
executing in the baseboard management controller of the server computer a monitor command concerning the status of the bus; and
transmitting the results of the monitor command to the client computer.

2. The method for monitoring the status of a bus of a server computer from a client computer of claim 1, wherein the server management software functions according to the Intelligent Platform Management Interface (IPMI) protocol.

3. The method for monitoring the status of a bus of a server computer from a client computer of claim 1, wherein the bus is a bus between the baseboard management controller and another component of the server computer.

4. The method for monitoring the status of a bus of a server computer from a client computer of claim 3, wherein the bus is an I²C bus.

5. The method for monitoring the status of a bus of a server computer from a client computer of claim 1, wherein the step of establishing a data structure comprises the step of saving the data structure to a nonvolatile memory location accessible by the baseboard management controller.

6. The method for monitoring the status of a bus of a server computer from a client computer of claim 1, further comprising the step of displaying the results of the monitor command at a display associated with the server computer.

7. The method for monitoring the status of a bus of a server computer from a client computer of claim 1, further comprising the step of recording the results of the monitor command in a nonvolatile memory location accessible by the baseboard management controller.

8. The method for monitoring the status of a bus of a server computer from a client computer of claim 1,
wherein the server management software functions according to the Intelligent Platform Management Interface (IPMI) protocol;
wherein the bus is an I²C bus between the baseboard management controller and another component of the server computer; and
wherein the step of establishing a data structure comprises the step of saving the data structure to a nonvolatile memory location accessible by the baseboard management controller; and
further comprising the steps of:
displaying the results of the monitor command at a display associated with the server computer; and
recording the results of the monitor command in a nonvolatile memory location accessible by the baseboard management controller.

9. A method for monitoring the status of a bus of a server computer, wherein the server computer comprises a controller coupled to one or more components by the bus, and wherein the bus has been defined in a server management program as having the characteristics of a sensor, comprising:
receiving at the controller a command to evaluate the status of the bus;
executing the command at the controller; and
returning the result of the command, wherein the results of the command correspond to the data structure defining the bus as a sensor in a server management program, and wherein the data structure was previously saved to a nonvolatile storage location associated with the controller.

10. The method for monitoring the status of a bus server of claim 9, wherein the server management program. functions according to the Intelligent Platform Management Interface (IPMI).

11. The method for monitoring the status of a bus server of claim 9, wherein the bus is a bus between the controller of the server and one or more components of the server.

12. The method for monitoring the status of a bus server of claim 9, wherein the bus is an I²C bus.

13. The method for monitoring the status of a bus server of claim 9, wherein the controller is a baseboard management controller.

14. The method for monitoring the status of a bus server of claim 9, wherein the command to evaluate the bus is issued by a client computer, and wherein the result of the command is returned to a client computer.

15. The method for monitoring the status of a bus server of claim 9, further comprising the step of saving the result of the command to a nonvolatile storage area associated with the controller.

16. The method for monitoring the status of a bus server of claim 9, further comprising the step of displaying the result of the command at a display associated with the server computer.

17. A method for monitoring the status of a bus in a server computer, wherein the bus has been defined in a server management program as having the characteristics of a sensor, comprising:
periodically executing a command in the server computer to monitor the status of the dedicate bus of the server computer, wherein the result of the command corresponds to the data structure defining the bus as a sensor in a server management program, and wherein the data structure was previously saved to a nonvolatile storage location associated with the controller; and
if the result of the command indicates that an error is present on the bus, saving the result of the command to a nonvolatile storage area in the server computer.

18. The method for monitoring the status of a bus in a server computer of claim 17, wherein the command is executed in a baseboard management controller in the server computer and wherein the nonvolatile storage area is accessible by the baseboard management controller.

19. The method for monitoring the status of a bus in a server computer of claim 17, wherein the server management program functions according to the Intelligent Program Management Interface (IPMI).

20. The method for monitoring the status of a bus in a server computer of claim 17, wherein the dedicate bus is an I²C bus.
